(19) United States
(12) Patent Application Publication
(10) Pub. No.: US 2022/0072549 A1
(43) Pub. Date: Mar. 10, 2022

(54) MICROFLUIDIC CONCENTRATING PARTICLIZERS

(71) Applicant: Hewlett-Packard Development Company, L.P., Spring, TX (US)

(72) Inventors: Viktor Shkolnikov, Palo Alto, CA (US); Alexander Govyadinov, Corvallis, OR (US)

(73) Assignee: Hewlett-Packard Development Company, L.P., Spring, TX (US)

(21) Appl. No.: 17/417,280

(22) PCT Filed: Apr. 30, 2019
(86) PCT No.: PCT/US2019/029916

§ 371 Date: Jun. 22, 2021

(51) Int. Cl. B01L 3/00; G01N 1/40; B01F 13/00

(52) U.S. Cl. CPC B01L 3/502761; G01N 1/4077; B01F 13/0064; B01L 2200/0652; B01D 29/445; B01L 2200/027; B01L 2400/0487; G01N 2001/4088; B01L 2300/0681

(57) ABSTRACT

The present disclosure relates to a microfluidic concentrating particlizers including a particle generator, a particle concentrator, and a fluid movement network. The particle generator includes a sample inlet microchannel and a reagent inlet microchannel. The sample inlet microchannel is operable to direct a source sample. The reagent inlet microchannel is operable to direct reagent. The source sample and reagent come in contact to form a sample fluid dispersion including sample-modified particulates and fluid. The particle concentrator includes a filtering chamber fluidly coupled to the particle generator to concentrate sample-modified particulates relative to the fluid. The fluid movement network includes multiple pumps to generate fluidic flow through both the particle generator and the particle concentrator.

### BACKGROUND

In biomedical, chemical, and environmental testing, the ability to separate and/or concentrate undissolved particles from liquids can be desirable. As the quantity of available assays for undissolved particles from liquids increases, so does the demand for the ability to concentrate and/or remove particles from fluids.

### BRIEF DESCRIPTION OF THE DRAWING

FIG. 1 graphically illustrates a schematic view of an example microfluidic concentrating particlizer in accordance with the present disclosure;

FIG. 2 graphically illustrates a schematic view of an example microfluidic concentrating particlizer in accordance with the present disclosure;

FIG. 3 graphically illustrates a schematic view of an example microfluidic concentrating particlizer in accordance with the present disclosure;

FIG. 4 graphically illustrates a schematic view of an example microfluidic concentrating particlizer in accordance with the present disclosure;

FIG. 5 graphically illustrates a schematic view of an example microfluidic concentrating particlizer in accordance with the present disclosure;

FIG. 6 graphically illustrates a schematic view of an example microfluidic concentrating particlizer in accordance with the present disclosure;

FIG. 7 graphically illustrates a schematic view of an example microfluidic concentrating particlizer in accordance with the present disclosure;

FIG. 8 graphically illustrates a schematic view of an example microfluidic concentrating particlizer system in accordance with the present disclosure; and

FIG. 9 is a flow diagram illustrating an example method of concentrating particles in accordance with the present disclosure.

### DETAILED DESCRIPTION

In many biological, chemical, and environmental assays, particles of interest can be dissolved in a fluid sample and can be present in very low concentrations. In accordance with examples of the present disclosure, particles of interest can be modified to form particles or enhance the size or other features of particles out of a fluid sample and concentrated in a fixed liquid volume, thereby permitting detection of the particles that would otherwise be dissolved in a solute at low concentrations.

This can be useful in circumstances where a component of interest (nucleic acid, small molecules, etc.) is dissolved in a solution and/or interfering species are present. This can also be useful in circumstances were a component of interest is present at low concentrations, among other circumstances. Thus, with some analysis protocols, testing may be challenging without particlizing the component of interest out of the solvent and concentrating the component of interest, or in some examples, even if there are enough particle samples, by increasing the particulate concentration, more accurate assays or higher collection/separation yields may be possible, etc. For example, by particlizing and concentrating the component of interest from a sample fluid, analysis can occur (or can occur with greater resolution) in some examples. Alternatively, a fluid of interest may become more useful or may be more accurately evaluated after removal of a solute therefrom, e.g., the portion that does not include the concentrated particles. In either or both instances, the microfluidic particle concentrating generator described herein can prepare a sample fluid for further use and/or assay of the sample fluid by transforming the initial sample fluid from a first state to multiple separate fluids with different particle concentrations.

In accordance with example of the present disclosure, a microfluidic concentrating particlizer includes a particle generator, a particle concentrator, and a fluid movement network. The particle generator includes a sample inlet microchannel and a reagent inlet microchannel. The sample inlet microchannel to direct source sample and the reagent inlet microchannel to direct reagent so that source sample and reagent come in contact to form a sample fluid dispersion including sample-modified particulates and fluid. The particle concentrator includes a filtering chamber fluidly coupled to the particle generator to concentrate sample-modified particulates relative to the fluid. The fluid movement network includes multiple pumps to generate fluidic flow through both the particle generator and the particle concentrator. In one example, the particle generator includes a mixing channel to receive source sample from the sample inlet microchannel, a reagent microfluidic channel to receive reagent from the reagent inlet microchannel, and further includes a mixing chamber or a mixing microfluidic channel where the source sample and the reagent are brought together to interact to form the sample fluid dispersion. In another example, the sample inlet microchannel is fluidly coupled to a sample inlet pump to control a sample-containing volume of fluid introduced through the sample inlet microchannel, the reagent inlet microchannel is fluidly coupled to a reagent inlet pump to control a reagent-containing fluid volume introduced through the reagent inlet microchannel, or both the sample pump and the reagent pump are present to respectively control a sample-containing volume of fluid introduced through the sample inlet microchannel and a reagent-containing fluid volume introduced through the reagent inlet microchannel. In yet another example, the microfluidic concentrating particlizer further includes a lysis chamber or a lysis microfluidic channel to lyse cells of the source sample after being introduced via the sample inlet microchannel, but before entering the filtering chamber of the particle concentrator. In a further example, the lysis chamber or lysis microfluidic channel is fluidly coupled to chemical lysis fluidics, a sheering lysis mechanism or device, or a heating lysis mechanism or device. In one example, the particle concentrator includes a dispersion inlet microchannel to receive and deliver the sample fluid dispersion from the particle generator to the filtering chamber, a particle outlet microchannel fluidly coupled to the filtering chamber to receive a sample-modified particulate-concentrated fluid, a filter outlet microchannel fluidly coupled to the filtering chamber to receive a sample-modified particulate-ablated fluid. In another example, the fluid movement network includes multiple pumps to generate fluid flow through the sample inlet microchannel and the reagent inlet microchannel into the filtering chamber, sample-modified particulate-ablated fluid flow into the filter outlet microchannel, and sample-modified particulate-concentrated fluid from the filtering chamber into the particle outlet microchannel. In yet another example, the multiple pumps include an inertial pump, a fluid ejector, or a combination thereof. In a further example, the microfluidic concentrating particlizer further includes a first diluent inlet microchannel fluidly coupled with the particle generator to introduce diluent or buffer into the particle generator, a second diluent microchannel fluidly coupled with the particle concentrator to introduce diluent or buffer into the particle concentrator, or both. In another example, the microfluidic concentrating particlizer further includes a second sample inlet microchannel to receive a second source sample, a second reagent inlet microchannel to receive a second reagent, or both. In yet another example, the particle generator and the particle concentrator are fluidly coupled so that sample fluid dispersion forms within the filtering chamber of the particle concentrator at a relative upstream location and filtration and separation occurs at a relative downstream location relative to channel cross-sectional area average.

Further presented herein, is a microfluidic concentrating particlizer system that includes a source sample, a reagent, a particle generator, a particle concentrator, and a fluid movement network. The particle generator includes a sample inlet microchannel and a reagent inlet microchannel. The sample inlet microchannel to direct the source sample and the reagent inlet microchannel to direct the reagent so that source sample and reagent come in contact to form a sample fluid dispersion including sample-modified particulates and fluid. The particle concentrator includes a filtering chamber fluidly connected to the particle generator to concentrate sample-modified particulates relative to the fluid. The fluid movement network includes multiple pumps to generate fluidic flow through both the particle generator and the particle concentrator. In one example, the source sample, the reagent, or both are in the form of particles dispersed in a fluid.

Also presented herein is a method of concentrating particles. The method includes, introducing a source sample and a reagent into a particle concentrator to form a sample fluid dispersion including sample-modified particulates and fluid; and concentrating sample-modified particulates from the sample fluid dispersion by directing a sample-modified particulate-ablated fluid through a filter outlet microchannel and directing a sample-modified particulate-concentrated fluid through a particle outlet microchannel. In one example, the method further includes, lysing cells in the source sample or the sample fluid dispersion; introducing diluent to the source sample, the reagent, or the sample fluid dispersion; introducing a second source sample into the particle concentrator; introducing a second reagent into the particle concentrator; introducing particulate source sample as a source sample dispersion; introducing particulate reagent as a reagent dispersion; introducing solvated source sample as a source sample solution; introducing solvated reagent as a reagent solutions; or any combination thereof.

It is noted that when discussing the microfluidic concentrating particlizer, microfluidic concentrating particlizer system, or the method of concentrating particles herein, such discussions can be considered applicable to one another whether or not they are explicitly discussed in the context of that example. Thus, for example, when discussing a particle generator in the context of a microfluidic concentrating particlizer, such disclosure is also relevant to and directly supported in the context of the microfluidic concentrating particlizer system and/or the method of concentrating particles, and vice versa.

In the present disclosure, it is noted that the term “particles” refers to particulate materials of various types, including cells, microorganisms, analytes, other organic particulates, inorganic particulates, etc., that can be present in dissolved or undissolved form in a sample fluid. In one example, the particles can be biological particles for biological assays or use, but other types of particles can likewise be concentrated. A “sample fluid” can refer to a fluid obtained for analysis and can include the component of interest to be particlized, concentrated, and/or separated. The terms “particlize,” particlizing,” or the like refers generating particles or increasing particle size using a reagent and source sample. Forming particles can be by any of a number of mechanisms or devices, such as mechanisms or devices for precipitation, adsorption, polymerization, or agglomeration, for example. The terms “particle-ablated” or “particle-concentrated” when referring to a sample fluid refers to the multiple portions of the sample fluid that remain after a plurality of particles are concentrated in accordance with the present disclosure. For example, during concentration of the particles, the portion that includes an increased concentration of particles can be referred to as the “particle-concentrated fluid” and the portion where particle concentration has been reduced can be referred to as “particle-ablated fluid.” Both are fluid portions that are generated from the source sample fluid. As a note, the source sample fluid can be of itself a previously “concentrated” or “ablated” sample fluid, as may be the case with cascading or sequential microfluidic particle concentrators.

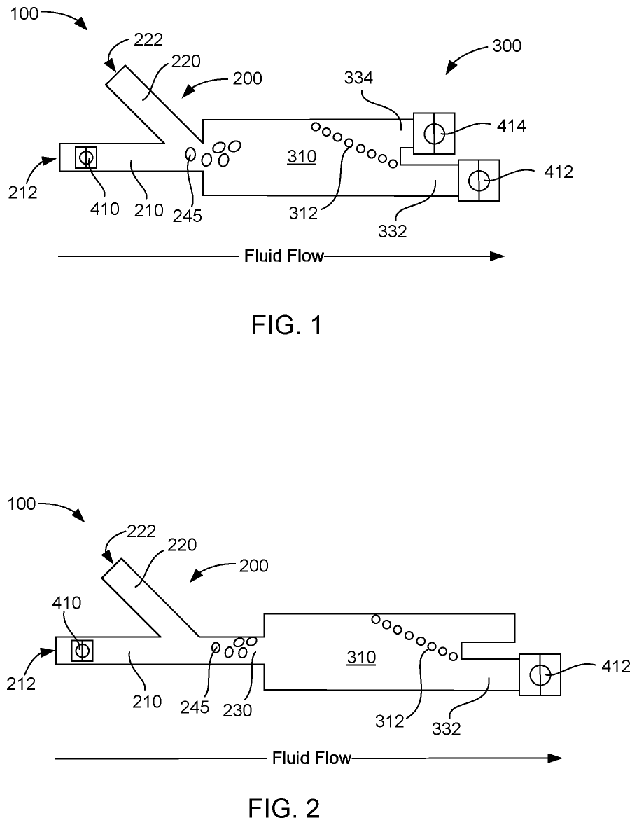

In accordance with these definitions, examples, and disclosure herein, FIGS. 1-7 depict various microfluidic concentrating particlizers at 100 and FIG. 8 depicts an example microfluidic concentrating particlizer as part of a microfluidic concentrating particlizer system. Any of the particle generator microfluidic generators illustrated and/or described herein could be used in the examples shown in FIG. 8, but for brevity, one specific example has been selected, namely the example shown and described in FIG. 2. Any of these examples can include various features, with some features common from example to example. Thus, the reference numerals used for FIGS. 1-8 that refer to common features are the same throughout to avoid redundancy, but it is understood that various other structural configurations can be used in accordance with the principles described herein. Thus, discussion of a specific FIG. can be relevant to all other examples and FIGS. shown and described herein, and not ever reference numeral is re-described in the context of the various figures for brevity.

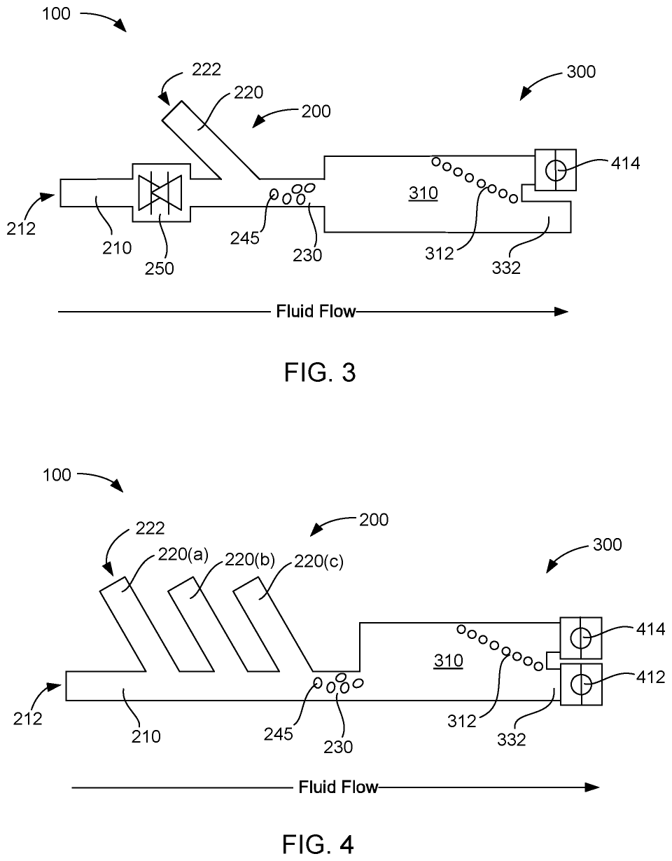

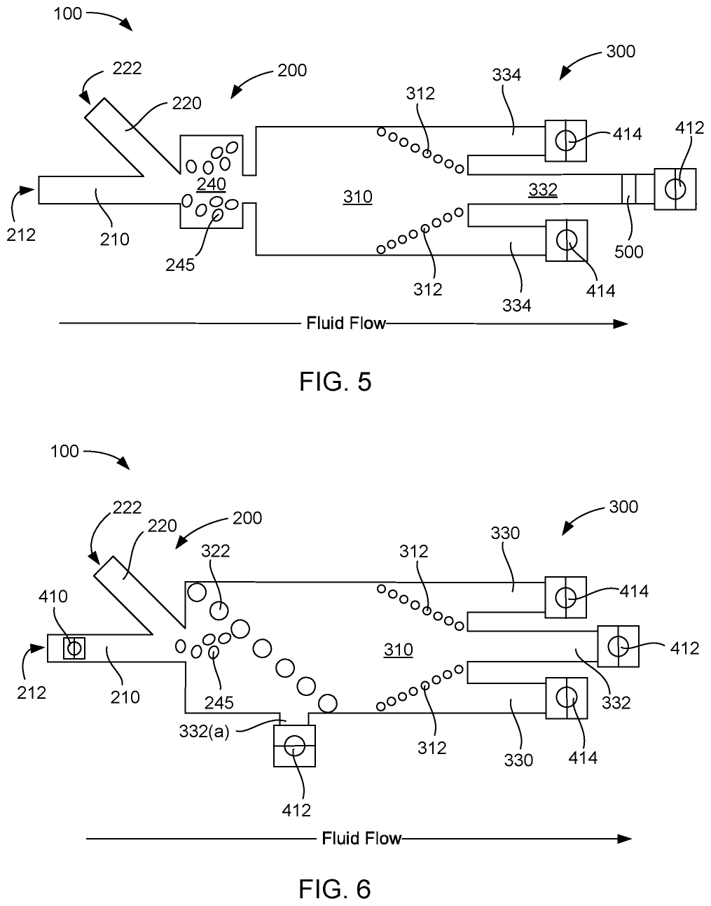

In FIGS. 1-8, with initial emphasis on the example shown in FIG. 1, the microfluidic concentrating particlizer 100 can include an a particle generator 200 including a sample inlet microchannel 210 and a reagent inlet microchannel 220. The microfluidic concentrating particlizer can also a particle concentrator 300 including a flirting chamber 310. The microfluidic concentrating particlizer can also include a fluid movement network 410, 412, 414. In the example shown, the pumps of any of these types can be located and used as a filter outlet pump 414 located in a filter outlet microchannel 334, or can be located and used as a particle outlet pump 412 located in a particle outlet microchannel 332, or located and used as an inlet pump 410 located in the inlet microchannel of the particle generator. It is noted that the filter outlet pump(s), the particle outlet pump(s), and/or the inlet pump(s) that may be present are given these names relative to their function. However, these pumps can operate fluidically by any of a number of mechanisms or devices, e.g., in the form of inertial pumps, ejection pumps, and/or other types of pumps as described in greater detail hereinafter. Also shown is a mechanical 312 filter in the filtering chamber that provides filtration of particles 245 so that particle-ablated fluid can pass into the microchannel to be pumped or ejected from the filter outlet microchannel. Other fluid movement network configurations can likewise be used, such as that shown in FIG. 2, FIG. 3, FIG. 4, and FIG. 5, for example. In those examples, there can be fewer or additional pumps used. These and other arrangements can generate appropriate fluid flow for various microfluidic concentrating particlizer.

The sample inlet microchannel 210 can be structurally configured for depositing and receiving a source sample. In one example, a sample inlet microchannel can include a source sample opening 212 to receive the source sample. The source sample opening can provide fluid access for a source sample into the particle generator 200. In a further example, the source sample opening can be present to provide a fitting for connecting to a liquid dispenser, such as a syringe or a gas-tight syringe, or can include a fitting that can be penetrable by a liquid dispenser, such as a needle. The fitting for example, could include a male luer, female luer, threaded connector, bushing, elastomeric seal, or a tapered insert. The source sample microchannel can be a chamber suitable for movement of a source sample therethrough and can be fluidly connected to the reagent inlet microchannel. The inlet microchannel 220 can be structurally configured for depositing and receiving a reagent so that the reagent can come in contact with a source sample to form a sample fluid dispersion including sample-modified particulates and fluid. In one example, a reagent inlet microchannel can include a reagent opening 222 to receive the reagent. In a further example, the reagent opening can be configured to include a fitting for connecting to a liquid dispenser and can be as described above with respect to fittings. The fitting for example, could include a male luer, female luer, threaded connector, bushing, elastomeric seal, or a tapered insert. The source sample microchannel can be a chamber suitable for movement of a source sample therethrough and can be fluidly connected to the reagent inlet microchannel.

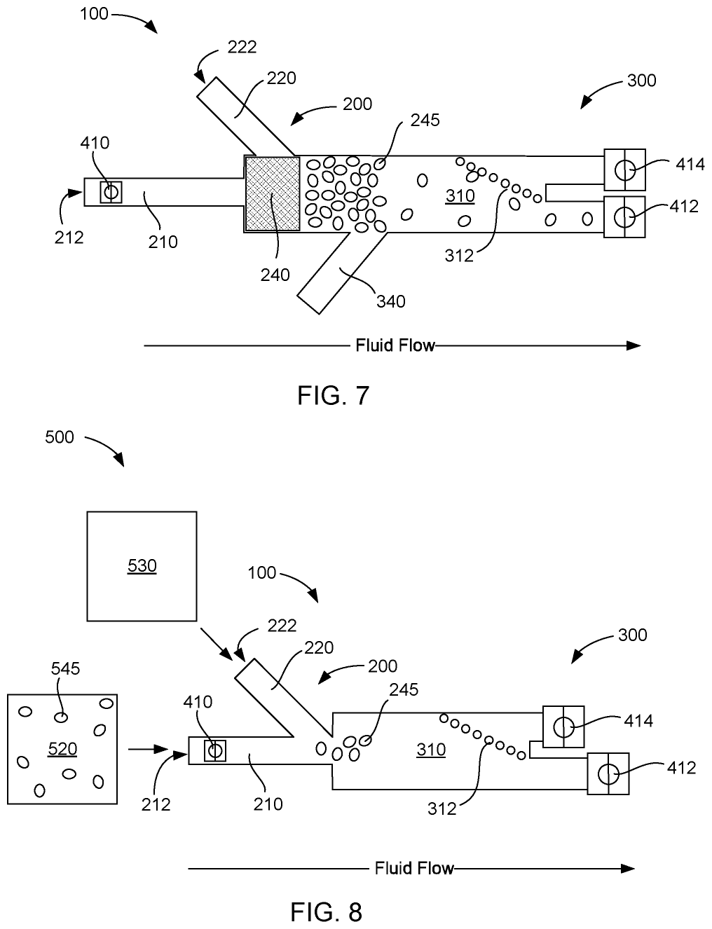

In some examples, the particle generator can further include a region that permits mixing or otherwise combining of the source sample and a reagent. For example, the particle generator can further include a mixing channel 230 as depicted in FIGS. 2-4. The mixing channel can receive the source sample from the sample inlet microchannel and the reagent from the reagent inlet microchannel. The mixing channel can be a location where the source sample and the reagent contact one another and mixing can occur due to the flow of the reagent and the source sample. In other examples, the particle generator can further include a particlizer mixing chamber 240. See FIG. 5. The particlizer mixing chamber can be present in addition to a mixing channel, or instead of a mixing channel. The particlizer mixing chamber can be a chamber structurally configured to encourage mixing of a source sample and a reagent. In some examples, the particlizer mixing chamber can share a common chamber wall with the filtering chamber 310 of the particle concentrator as depicted in FIG. 7.

In other examples, the particle generator can further include a lysis chamber or lysis microfluidic channel 250 as shown in FIG. 3. The lysis chamber or lysis microfluidic channel can lyse cells of the source sample after being introduced via the sample inlet microchannel, but before entering the filtering chamber of the particle concentrator. The Lysis chamber or lysis microfluidic cannel, for example, can lyse the cell wall of cells in a fluid sample thereby permitting the organelles to be released therefrom. The organelles can then interact with the reagent and can then permit the organelle bound with reagent to be used in further analysis. For example, nucleic acids can be bound to silica particles.

The lysis chamber or lysis microfluidic channel can lyse components of a source sample via chemical lysis fluidics, sheering lysis mechanism or device, or a heating lysis mechanism or device. A chemical lysis fluidics, lysis chamber or lysis microfluidic channel can include a lysis inlet opening and lysis inlet microchannel to allow a chemical lysis fluid to enter the lysis chamber or lysis microfluidic channel. Chemical lysis fluids can include sodium dodecyl sulphate; 3-[(3-cholamidopropyl)dimethylammonio]-1-proanesulphonate, 3-[(3-cholamidopropyl)dimethylammonio]-2-hydroxy-1-propanesulfonate, urea, guanidine, ethylenediaminetetraacetic acid (EDTA), cetyltrimethylammonium bromide (CTAB); and the like. A sheering lysis mechanism or device can include a mechanical disruption mechanism or device, such as a sheers, sheering screens, sheering constrictions, sheering flow, and the like. A heating lysis mechanism or device can include a thermal resistor. In one example, a heating lysis mechanism or device can include a thermal inkjet resistor.

In some examples, the particle generator 200 can include additional reagent inlet microchannels, 220(a), 220(b), and 220(c) as depicted in FIG. 4. The various reagent inlet microchannels can independently include reagent openings, shown by one example at 222. In one example, the additional reagent inlet microchannels can allow for additional reagent of the same type to be loaded into the microfluidic concentrating particlizer. In other example the additional reagent inlet microchannels can allow for different reagents to be added to the microfluidic concentrating particlizer 100.

The particle generator 200 can be fluidly connected to the particle concentrator 300 and sample fluid exiting the particle generator can enter a filtering chamber 310 of the particle concentrator. The particle concentrator can concentrate sample-modified particulates relative to the fluid. The particle concentrator can be used to concentrate particles 245 having an average particle size ranging from 100 nm to 30 μm, from 500 nm to 20 μm, or from 750 nm to 15 μm. “Particle size” refers to the diameter of spherical particles, or to the longest dimension of non-spherical particles. Particle size can be measured by differential light scattering (DLS) or particle sizing via microscopic observation.

The filtering chamber 310 can be a linear chamber suitable for movement of a fluid therethrough. In one example, the filtering chamber can have an average cross-sectional size perpendicular to flow of the sample fluid ranging from 50 μm to 500 μm. In other examples, the filtering chamber can have an average cross-sectional size perpendicular to flow of the sample fluid ranging from 100 μm to 300 μm, from 75 μm to 250 μm, from 50 μm to 400 μm, or from 200 μm to 400 μm. An “average cross-sectional size” as used herein refers to a defined diameter if not circular, the diameter area of the cross-section reconfigured as a circular cross-section.

The filtering chamber 310 can include a mechanical filter 312. The mechanical filter can include a sieve, baleen, lateral displacement bar, a size exclusion chromatographic structure, or a combination thereof. In one example, the mechanical filter can include multiple lateral displacement bars. When present, lateral displacement bars can include a space therebetween that can range from 10% to 200% of the particle size. In yet other examples of mechanical filters, the space therebetween can range from 10% to 20%, from 50% to 70%, from 110% to 200%, or from 90% to 110% of the particle size. In a further example, the mechanical filter can include a sieve.

In an example, the mechanical filter 312 can include openings sized to prevent particles of interest from passing therethough. In one examples, the openings can be sized to prevent particles having an average size from 5 μm to 50 μm, from 5 μm to 17 μm, from 20 μm to 45 μm, from 15 μm to 35 μm, from 5 μm to 7 μm, from 9 μm to 12 μm, or from 12 μm to 17 μm passing therethrough. In yet other examples, the mechanical filter can include openings that can be larger than the particles of interest but can be positioned in a manner that minimizes the quantity of particles that pass therethrough.

In some example, the mechanical filter 312 can be a tangential filter. Tangential filtration can be crossflow filtration where fluid flow occurs at an angle other than 90° in relation to the membrane face. In tangential filtration a relationship between mechanical filter and a direction of fluid flow can be at an angle other than 0° and 90° with respect to the relationship between one another. In one example, the mechanical filter can be tangentially oriented at an angle from 5° to 170° with respect to a direction of fluid flow through the filtering chamber and into the filter outlet microchannel, thereby directing larger particles disallowed by the mechanical filter toward the particle outlet microchannel. In yet other examples, the mechanical filter can be tangentially oriented at an angle from 5° to 45°, from 30° to 150°, from 10° to 130°, or from 50° to 150° with respect to a direction of fluid flow through the filtering chamber and into the filter outlet microchannel, thereby directing larger particles disallowed by the mechanical filter toward the particle outlet microchannel. The angle and placement of the mechanical filter in the filtering chamber can direct particles that do not pass through the mechanical filter to the particle outlet microchannel.

After passing through the mechanical filter 312, fluid with minimal quantities of particles of interest to fluid excluding the particles of interest, i.e. particle-ablated fluid can pass to the filter outlet microchannel, 334. The filter outlet microchannel can be fluidly connected to the filtering chamber to receive a particle-ablated fluid formed by passing through the mechanical filter. In some examples, the microfluidic particle concentrator can include multiple mechanical filters (as depicted in FIGS. 5 and 6) and/or multiple filter outlet microchannels (as depicted in FIGS. 5 and 6).

Particles 245 that can be ablated from the sample fluid can be directed by the mechanical filter 312 toward the particle outlet microchannel 332. The particle outlet microchannel can be fluidly connected to the filtering chamber 310 to receive a particle-concentrated fluid including a plurality of particles that cannot be permitted to pass through the mechanical filter. The particle outlet microchannel can be fluidly connected to the filtering chamber. In some examples, the mechanical filter cannot extend over or across an opening to the particle outlet microchannel. In some examples, the particle outlet microchannel can have an average cross-sectional size perpendicular to flow of the sample fluid ranging from the 1% larger to 50% larger than a size of the largest particle of the large particles disallowed by the mechanical filter. In yet other examples, the particle outlet microchannel can have an average cross-sectional size perpendicular to flow of the sample fluid ranging from 5% larger to 35% larger, from 15% larger to 45% larger, or from 1% to 20% larger than a size of the largest particle of the particles disallowed by the mechanical filter.

In yet another example, as shown by way of example in FIG. 5, the particle concentrator can further include a coulter counter electrode 500, or multiple coulter counter electrodes, to detect electrical resistance as the sample fluid passes therethrough. A coulter counter electrode can be located at the filter outlet microchannel, the particle outlet microchannel, or a combination thereof. Detecting electrical resistance can permit the detection of individual particles, and/or a concentration of a solution as a fluid passes. A coulter counter electrode can provided added control to permit the ejection of specified quantities of particles. In some examples, a coulter counter electrode can be positioned at the filter outlet microchannel, the particle outlet microchannel, or the combination thereof.

The location of the particle outlet microchannel 332 can be parallel to fluid flow or can be perpendicular to fluid flow. For example, the particle outlet microchannel can be located at the end of the filtering chamber 310 as shown in FIGS. 1-8. In yet other examples, the particle outlet microchannel can be perpendicular to fluid flow through the filtering chamber as illustrated by an auxiliary particle outlet microchannel 332(a) in FIG. 6.

In another example, as shown in FIG. 6, the particle concentrator can include additional mechanical filter(s) that are not specifically associated with a filter outlet microchannel 332, referred to herein as “auxiliary mechanical filter(s)” 322. The auxiliary mechanical filter can be as described above with respect to the mechanical filter, but may be positioned at other locations than those specifically associated with a filter outlet microchannel. For example, an auxiliary mechanical filter may be associated with an auxiliary particle outlet microchannel. These types of combinations can be used to remove larger particles before arriving at the mechanical filter 312, the filter outlet microchannel 334, and the particle outlet microchannel 332 as described previously.

The auxiliary mechanical filter 322 can filter particles 245 of the same size or of a different size than particles that can be filtered by the mechanical filter 312. Filtering particles of the same size can minimize the potential for particles passing through the microfluidic particle concentrator uncollected. Filtering particles of a different size can permit separation and concentration of different sized particles in a single microfluidic particle concentrator. Filtering particles having a different size than particles filtered by a mechanical filter can occur by varying the space between components of the auxiliary mechanical filter. For example, an auxiliary mechanical filter including lateral displacement bars can have a larger space between individual lateral displacement bars than a spacing between individual lateral displacement bars of a mechanical filter. In yet another example, an auxiliary mechanical filter including a sieve can have a larger spacing between the mesh than the spacing between the mesh of a mechanical filter including a sieve. In some examples, there can be multiple auxiliary mechanical filters that can be arranged in a plurality of locations. For example, the particle concentrator can include two auxiliary mechanical filters. In yet other examples, the particle concentrator can include a series of auxiliary mechanical filters. For example, a particle concentrator can include from 3 to 20 auxiliary mechanical filters, from 3 to 8 auxiliary mechanical filters, or from 3 to 14 auxiliary mechanical filters. The auxiliary mechanical filter can be positioned in the filtering chamber prior to the mechanical filter along a fluid flow path, such that a sample of fluid flowing through the particle concentrator can contact the auxiliary mechanical filter prior to contacting the mechanical filter. The auxiliary mechanical filter can direct a first stage of particle-concentrated fluid to an auxiliary particle outlet microchannel, while permitting a first stage of particle-ablated fluid to pass therethrough to be further separated at the by the mechanical filter to thereby form a second stage of particle-concentrated fluid and a second stage of particle-ablated fluid.

In another example, the particle concentrator can further include a diluent inlet microchannel 340. See FIG. 7. The diluent inlet microchannel can permit particulates present in high concentrations following particlizing to be reduced in concentration in order to continue fluid flow through the device as depicted in FIG. 7.

Regardless of the configuration shown in FIGS. 1-8, fluid flow through the microfluidic concentrating particlizer can be controlled by the fluid movement network 410, 412, and 414. The fluid movement network can include multiple pumps to generate fluid flow through the sample inlet microchannel and the reagent inlet microchannel into the filtering chamber, sample-modified particulate-ablated fluid flow into the filter outlet microchannel and sample-modified particulate-concentrated fluid from the filtering chamber into the particle outlet microchannel.

The fluid movement network, for example, can include any combination of pumps that can generate fluid flow through the microfluidic concentrating particlizer. For example, the fluid movement network can include an inlet pump 412 located within an inlet microchannel, such as a sample inlet microchannel, a reagent inlet microchannel, a diluent inlet microchannel, and/or dispersion inlet microchannel. The fluid movement network could include a filter outlet pump 414 located in the filter outlet microchannel 334. The fluid movement could include a particle outlet pump 412 located in the particle outlet microchannel 332. The fluid movement network can include an inlet pump and a particle outlet pump. In another example, can include an inlet pump and a filter outlet pump. In yet another example, the fluid movement network can include a particle outlet pump and a filter outlet pump. In a further example, the fluid movement network can include an inlet pump, a filter outlet pump, and a particle outlet pump. The location of the pumps can be at locations that drive fluid flow in the “Fluid Flow” direction shown in the figures, and which can cause particle concentration/separation to occur. The Fluid Flow direction shown in these examples is considered to be an average or relative fluid flow of the microfluidic concentrating particlizer, and does not show every fluid flow vector that may be present at a given location.

The various pumps of the fluid movement network 410, 412, 414, etc., can include an inertial pump, fluid or drop ejector, DC electroosmotic pump, AC electroosmotic pump, diaphragm pump, peristaltic pump, capillary pump, or a combination thereof. An inertial pump may in and of itself include multiple pumps that work together to generate a net unidirectional fluid flow. A fluid or drop ejector can include pumps that operate in the same way as piezo inkjet printheads or thermal inkjet printheads, ejecting fluid from one microfluidic channel in a direction away from the channel (and into a chamber, into another microfluidic channel, or to the environment outside of the microfluidic concentrating particlizer. An inlet pump can generate fluid flow by “pushing” fluid through a microchannel and into the filtering chamber. On the other hand, fluid ejectors can generate a “pull” of fluid in the direction of the fluid flow.

The combination of pumps can generate fluid flow through the microfluidic concentrating particlizer 100 at a flow rate that can range from 10 pL/min to 50 mL/min. In other more specific example, the flow rate of fluid through the microfluidic concentrating particlizer can range from 10 pL/min to 30 mL/min, from 100 pL/min to 50 mL/min, from 1 mL/min to 50 mL/min, from 1 nL/min to 100 pL/min, from 10 10 nL/min to 100 nL/min, from 100 nL/min to 1 uL/min, or from 0.5 uL/min to 10 uL/min, for example. In some examples, the pump can include a thermal inkjet ejector, such as an ejector with 1,000 to 3,000 nozzles, e.g., about 2000 nozzles, pulling fluid therethrough at from 1 mL/min to 50 mL/min, e.g., about 30 mL/min.

In one example, the microfluidic concentrating particlizer 100 can be included as part of a microfluidic chip, such as a lab-on-a-chip device. The lab-on-a-chip device can be a point of care system. Incorporating the microfluidic concentrating particlizer in a lab-on-a-chip device can permit the analysis of reduced volumes of a sample fluid.

In another example, as shown in FIG. 8, a microfluidic concentrating particlizer system 500 can include a source sample 520 including a source particle 545 dissolved or dispersed therein (perhaps of a smaller size or having some other characteristic that would benefit from further particlizing), a reagent 530, and a microfluidic concentrating particlizer 100 including a particle generator 200, a particle concentrator 300, and fluid movement network 410, 412, 414. The particle generator can include a sample inlet microchannel 210 and sample opening 212 and a reagent inlet microchannel 220 and reagent opening 222, the sample inlet microchannel to direct the source sample and the reagent inlet microchannel to direct the reagent so that source sample and reagent come in contact to form a sample fluid dispersion including sample-modified particulates 245 and fluid. The particle concentrator can include a filtering chamber 310 fluidly connected to the particle generator to concentrate sample-modified particulates relative to the fluid. The fluid movement network can include multiple pumps to generate fluidic flow through both the particle generator and the particle concentrator. The microfluidic concentrating particlizer can be as described above. In one example, the source sample, the reagent, or both are in the form of particles dispersed in a fluid. In another example, though not shown, the reagent fluid can include reagent particles and the source solution can include material that interacts with the reagent particles, e.g., deposited thereon, etc.

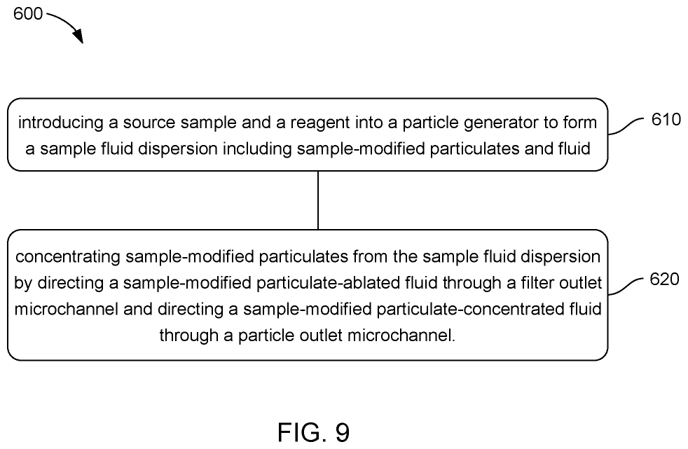

Turning to a further example, a flow diagram of a method 600 of concentrating particles is shown in FIG. 9. In one example, the method can include introducing 610 a source sample and a reagent into a particle generator to form a sample fluid dispersion including sample-modified particulates and fluid, and concentrating 620 sample-modified particulates from the sample fluid dispersion by directing a sample-modified particulate-ablated fluid through a filter outlet microchannel and directing a sample-modified particulate-concentrated fluid through a particle outlet microchannel. In one example, the method can further include lysing cells in the source sample or the sample fluid dispersion; introducing diluent to the source sample, the reagent, or the sample fluid dispersion; introducing a second source sample into the particle concentrator; introducing a second reagent into the particle concentrator; introducing particulate source sample as a source sample dispersion; introducing particulate reagent as a reagent dispersion; introducing solvated source sample as a source sample solution; introducing solvated reagent as a reagent solutions; or any combination thereof.

It is noted that, as used in this specification and the appended claims, the singular forms “a,” “an,” and “the” include plural referents unless the content clearly dictates otherwise.

As used herein, a plurality of items, structural elements, compositional elements, and/or materials may be presented in a common list for convenience. However, these lists should be construed as though members of the list are individually identified as a separate and unique member. Thus, no individual member of such list should be construed as a de facto equivalent of any other member of the same list solely based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or subranges encompassed within that range as if the numerical values and subranges are explicitly recited. For example, thickness from about 0.1 mm to about 0.5 mm should be interpreted to include the explicitly recited limits of 0.1 mm to 0.5 mm, and to include thicknesses such as about 0.1 mm and about 0.5 mm, as well as subranges such as about 0.2 mm to about 0.4 mm, about 0.2 mm to about 0.5 mm, about 0.1 mm to about 0.4 mm etc.

The terms, descriptions, and figures used herein are set forth by way of illustration and are not meant as limitations. Many variations are possible within the disclosure, which is intended to be defined by the following claims—and equivalents—in which all terms are meant in the broadest reasonable sense, unless otherwise indicated.

What is claimed is:

1. A microfluidic concentrating particlizer, comprising:
a particle generator including sample inlet microchannel and a reagent inlet microchannel, the sample inlet microchannel to direct source sample and the reagent inlet microchannel to direct reagent so that source sample and a reagent come in contact to form a sample fluid dispersion including sample-modified particulates and fluid;
a particle concentrator including a filtering chamber fluidly coupled to the particle generator to concentrate sample-modified particulates relative to the fluid; and
a fluid movement network including multiple pumps to generate fluidic flow through both the particle generator and the particle concentrator.

2. The microfluidic concentrating particlizer of claim 1, wherein the particle generator includes a mixing channel or particlizer mixing chamber to receive source sample from the sample inlet microchannel and reagent from reagent inlet microchannel where the source sample and the reagent are brought together to interact to form the sample fluid dispersion.

3. The microfluidic concentrating particlizer of claim 1, wherein the sample inlet microchannel is fluidly coupled to a sample inlet pump to control a sample-containing volume of fluid introduced through the sample inlet microchannel, the reagent inlet microchannel is fluidly coupled to a reagent inlet pump to control a reagent-containing fluid volume introduced through the reagent inlet microchannel, or both the sample pump and the reagent pump are present to respectively control a sample-containing volume of fluid introduced through the sample inlet microchannel and a reagent-containing fluid volume introduced through the reagent inlet microchannel.

4. The microfluidic concentrating particlizer of claim 1, further comprising a lysis chamber or a lysis microfluidic channel to lyse cells of a sample after being introduced via the sample inlet microchannel, but before entering the filtering chamber of the particle concentrator.

5. The microfluidic concentrating particlizer of claim 4, wherein the lysis chamber or lysis microfluidic channel is fluidly coupled to chemical lysis fluidics, a sheering lysis mechanism or device, or a heating lysis mechanism or device.

6. The microfluidic concentrating particlizer of claim 1, wherein the particle concentrator includes a dispersion inlet microchannel to receive and delivery the sample fluid dispersion from the particle generator to the filtering chamber, a particle outlet microchannel fluidly coupled to the filtering chamber to receive a sample-modified particulate-concentrated fluid, a filter outlet microchannel fluidly coupled to the filtering chamber to receive a sample-modified particulate-ablated fluid.

7. The microfluidic concentrating particlizer of claim 6, wherein the fluid movement network including multiple pumps to generate fluid flow through the sample inlet microchannel and the reagent inlet microchannel and into the filtering chamber, sample-modified particulate-ablated fluid flow into the filter outlet microchannel, and sample-modified particulate-concentrated fluid from the filtering chamber into the particle outlet microchannel.

8. The microfluidic concentrating particlizer of claim 1, wherein the multiple pumps include an inertial pump, a fluid ejector, or a combination thereof.

9. The microfluidic concentrating particlizer of claim 1, further comprising a first diluent inlet microchannel fluidly coupled with the particle generator to introduce diluent or buffer into the particle generator, a second diluent microchannel fluidly coupled with the particle concentrator to introduce diluent or buffer into the particle concentrator, or both.

10. The microfluidic concentrating particlizer of claim 1, further comprising a second sample inlet microchannel to receive a second source sample, a second reagent inlet microchannel to receive a second reagent, or both.

11. The microfluidic concentrating particlizer of claim 1, wherein the particle generator and the particle concentrator are fluidly coupled so that sample fluid dispersion forms within the filtering chamber of the particle concentrator at a relative upstream location and filtration and separation occurs at a relative downstream location relative to channel cross-sectional area average.

12. A microfluidic concentrating particlizer system, comprising:
a source sample;
a reagent;
a particle generator including sample inlet microchannel and a reagent inlet microchannel, the sample inlet microchannel to direct the source sample and the reagent inlet microchannel to direct the reagent so that source sample and reagent come in contact to form a sample fluid dispersion including sample-modified particulates and fluid;
a particle concentrator including a filtering chamber fluidly connected to the particle generator to concentrate sample-modified particulates relative to the fluid; and
a fluid movement network including multiple pumps to generate fluidic flow through both the particle generator and the particle concentrator.

13. The system of claim 12, wherein the source sample, the reagent, or both are in the form of particles dispersed in a fluid.

14. A method of concentrating particles, comprising:
introducing a source sample and a reagent into a particle generator to form a sample fluid dispersion including sample-modified particulates and fluid; and
concentrating sample-modified particulates from the sample fluid dispersion by directing a sample-modified particulate-ablated fluid through a filter outlet microchannel and directing a sample-modified particulate-concentrated fluid through a particle outlet microchannel.

15. The method of claim 14, further comprising:
lysing cells in the source sample or the sample fluid dispersion;
introducing diluent to the source sample, the reagent, or the sample fluid dispersion;
introducing a second source sample into the particle concentrator;
introducing a second reagent into the particle concentrator;
introducing particulate source sample as a source sample dispersion;
introducing particulate reagent as a reagent dispersion;
introducing solvated source sample as a source sample solution;
introducing solvated reagent as a reagent solutions; or
any combination thereof.
